(19) United States
(12) Patent Application Publication
(10) Pub. No.: US 2026/0259406 A1
(43) Pub. Date: Sep. 3, 2026

(54) METHOD FOR TUNABLE CHROMATIC ABERRATION PROJECTION

(71) Applicant: University of Rochester, Rochester, NY (US)

(72) Inventors: Susana Marcos Celestino, Pittsford, NY (US); Tianlun Zou, Rochester, NY (US); Keith Robert Parkins, Rochester, NY (US)

(21) Appl. No.: 19/552,357

(22) Filed: Feb. 27, 2026

Related U.S. Application Data
(60) Provisional application No. 63/765,161, filed on Feb. 28, 2025.

(51) Int. Cl. G02B 27/00; G02B 27/14

(52) U.S. Cl. CPC G02B 27/005; G02B 27/141

(57) ABSTRACT

A method for the manipulation of chromatic aberration in an image viewed by a person in a tunable manner includes using one or more optotunable lenses to control focusing of two or more temporally or spatially separated different wavelengths of visible light independently and combining the independently controlled different wavelengths of light into a viewed polychromatic image. This allows controlled correcting, overcorrecting, or reversing the natural chromatic aberration of the eye or imposing the chromatic aberration imposed by a given correction.

This invention was made with government support under EY035009 awarded by the National Institutes of Health. The government has certain rights in the invention.

### FIELD OF DISCLOSURE

This disclosure generally relates to chromatic aberrations, and more particularly to systems and methods for tunably modifying chromatic aberration induced in a display viewed by a user.

### BACKGROUND

Chromatic aberration in the eye arises from the wavelength dependence of refractive index of the ocular components and the intraocular media. Longitudinal chromatic aberration (LCA) induces defocus across different wavelengths, and it has been measured in the human eye to be close to 2 Diopters across the visible spectrum. On the other hand, diffractive elements used for certain corrections are also known to modify chromatic aberrations in the eye. For example, multifocal intraocular lenses tend to correct chromatic aberration of the eye at near, due to the chromatic dependence of diffractive orders higher than zero. Chromatic aberration may influence accommodation (eye's ability to focus near and far) accuracy, and may play a role in the emmetropization process or in the disruption of normal emmetropization leading to myopia progression. While the effect of chromatic aberration on visual function is in general not well understood, recent theories of myopia development and control point to mechanisms of sign of focus detection and signaling for eye growth that would use chromatic cues.

The use of liquid crystal spatial light modulators has been explored for use in ocular aberration correction and manipulation, based on the chromatic effects of a phase wrapped profile in a display for wavelengths of light that are different than the design wavelength for the phase wrapped profile. While use of various wrapped defocus phase maps may be used to induce various LCA correction or manipulation effects, diffraction order leak and diffraction efficiency effects may lead to less than desirable performance.

Several applications will benefit for improved systems and methods for modifying the chromatic aberration induced in a display viewed by a user, when combined with the chromatic aberration of the eye. These include, among others, new therapies for myopia control which could rely on enhancing, correcting or manipulating chromatic aberration. Also, given the chromatic effects of certain multifocal corrections for myopia or presbyopia, visual simulators of myopia and presbyopia corrections will be more faithfully represented incorporating the chromatic effects imposed by those corrections.

### SUMMARY

In accordance with an embodiment of the disclosure, a method for the manipulation of chromatic aberration in an image viewed by a person in a tunable manner is disclosed, comprising using one or more optotunable lenses to control focusing of two or more temporally or spatially separated different wavelengths of visible light independently, and combining the independently controlled different wavelengths of light into a viewed polychromatic image, thereby allowing controlled correcting, overcorrecting, or reversing the natural chromatic aberration of the eye or imposing the chromatic aberration imposed by a given correction. In various embodiments, the two or more distinct visible wavelength channels include at least distinct RGB channels.

In one disclosed embodiment, visible light from a display may be spatially split into two or more distinct visible wavelength channels using dichroic mirrors and color filters, with each channel provided with an optotunable lens that allows adjusting the focus for each channel independently, and further comprising tuning the optotunable lens in each channel independently to modify the chromatic difference of focus between each channel as desired, and recombining and superimposing the independently focus controlled channels to produce a polychromatic image with controlled chromatic aberration viewed by a user.

In another disclosed embodiment, a display is illuminated by two or more visible wavelengths of light from a light source are temporally separated and superimposed by temporal multiplexing. To achieve this, a single optotunable lens is driven in a cycling sequence at a high speed, in synchronization with the wavelength sweeping, At a given time the image is illuminated with a wavelength with a vergence adjusted to the desired image focus for that wavelength. The polychromatic image by temporal superposition, featuring the desired chromatic focus for each wavelength. In various embodiments, the color sweeping in the viewed display may be achieved by use of a supercontinuum laser coupled with an acousto-optic tunable filter, by RGB LED pulsing, or by a combination of the display and a rotating filter wheel.

### BRIEF DESCRIPTION OF THE DRAWINGS

FIG. 1 illustrates a system in accordance with one embodiment of the disclosure which may be used for temporal multiplexing of separated wavelength of light which are independently controlled by a single optotunable lens in synchronization with temporal generation of the separated wavelengths of light.

FIG. 2 illustrates temporal synchronization of an optotunable lens and an acousto-optic tunable filter used with a supercontinuum laser in accordance with an embodiment of the disclosure.

FIG. 3 illustrates examples of high-frequency optotunable lens power measurement sequencing which may be used for correcting, Doubling and Overcorrecting LCA in an embodiment of the disclosure.

FIG. 4 illustrates a system in accordance with an embodiment of the disclosure which may be used for spatially splitting light from a polychromatic display into two or more distinct visible wavelength channels using dichroic mirrors and color filters, with each channel provided with an optotunable lens that allows adjusting the focus for each channel independently.

### DETAILED DESCRIPTION

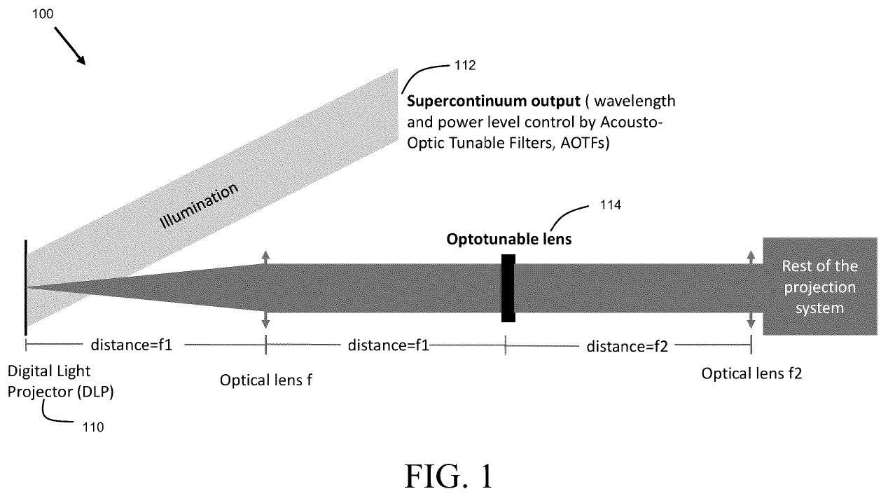

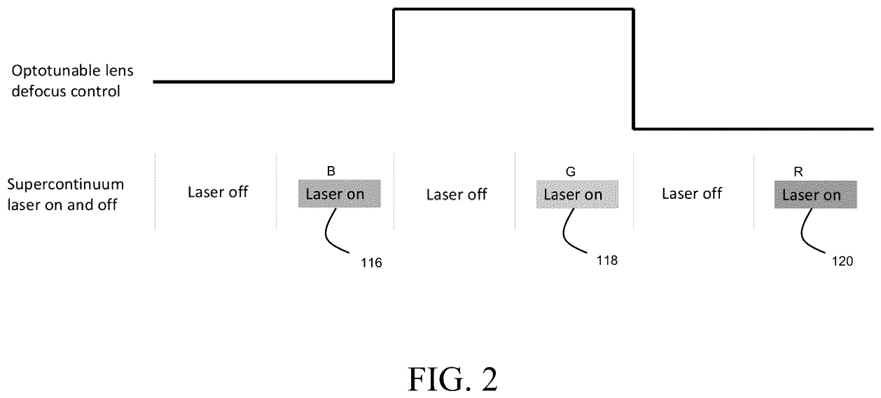

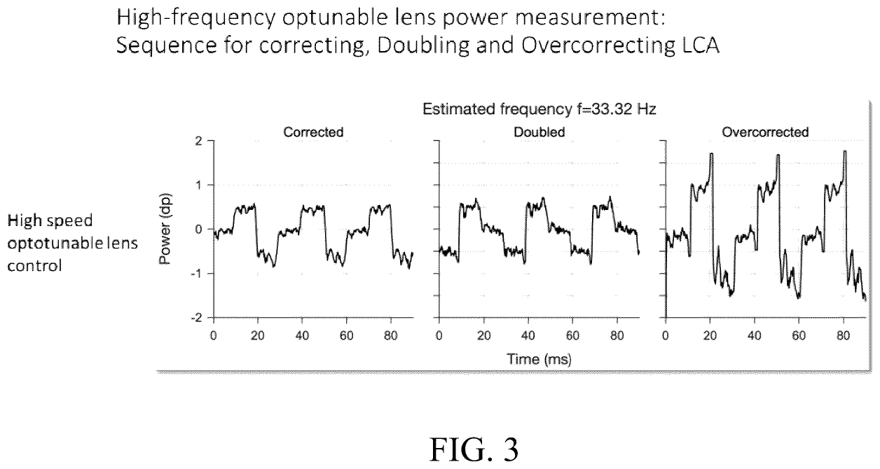

Temporal Multiplexing Method: In accordance with one embodiment 100 as shown in FIG. 1, a digital light processing (DLP) projector 110 is illuminated by a supercontinuum laser 112. By controlling the supercontinuum laser output's wavelength using an acousto-optic tunable filter (AOTF) which is driven to temporally separate the output into separate color channels which are synchronized as illustrated in FIG. 2 with an optotunable lens 114 at the pupil plane, such as blue (B) 116, Green (G) 118, and Red (R) 120. LCA can be controlled dynamically as shown in FIG. 3 by varying the optotunable lens power measurement to provide, e.g., correction, doubling, and overcorrecting of LCA, where tests are done at 33.32 Hz frequency (full cycle loops corresponding power for G, R and B). In specific embodiments, the acousto-optic tunable filter may provide sweeping 3 nm band width wavelengths (BW λs) from the supercontinuum laser which are synchronized with the temporal multiplexing optotunable lens. In an alternative temporal multiplexing embodiment, the R, G and B components of a projector (individual LEDs or a rotating filter wheel) can be synchronized with the optotunable lens to achieve the same goal.

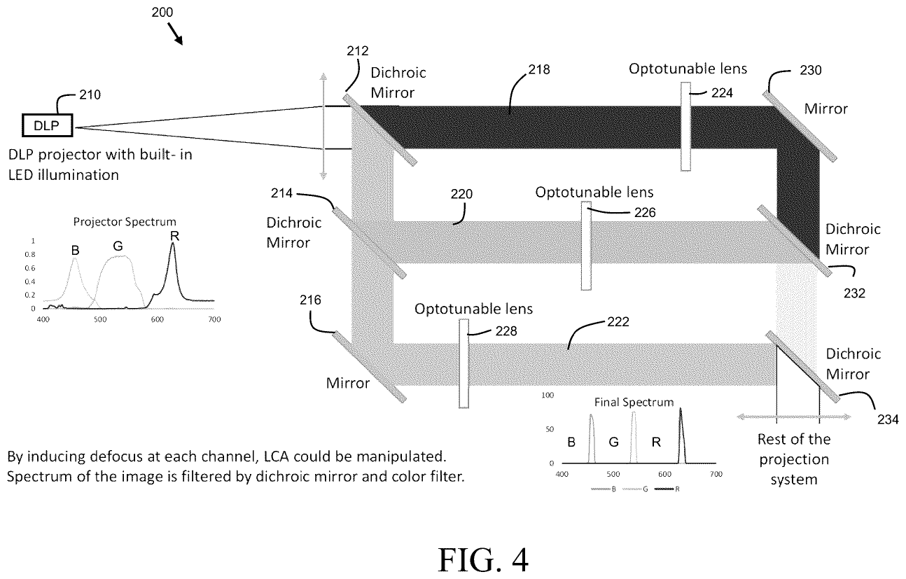

Static Method: In accordance with another embodiment 200 as shown in FIG. 4, a DLP projector 210 is illuminated using three LEDs with distinct central wavelengths. By employing a designed dichroic mirror 212, 214, 216 with color filters, the RGB channels 218, 220, 222, respectively, are spatially physically separated. In specific embodiments, the wavelength channels may be filtered to have band widths of, e.g., less than or equal to about 15 nm, or of less than or equal to about 10 nm. Pupil planes are created for each channel, and an optotunable lens 224, 226, 228 is used to control the convergence of each channel. The recombination of these three channels using dichroic mirrors 230, 232, 234 allows for the projection of LCA-controlled polychromatic images. This spatially separated static channel method can additionally encompass manipulation of the Transverse Chromatic aberration, by relatively laterally shifting the images corresponding to each channel in the recombination.

EXAMPLE: Longitudinal chromatic aberration (LCA) has been suggested to provide a cue for determining the sign of defocus, which may help bring targets into focus while accommodating and tell the proper emmetropization direction. However the exact role of LCA is still unclear. To investigate how LCA manipulation impacts accommodative lag (AL), three LCA control methods which can be implemented in an adaptive optics visual simulator (AOVS) were developed and evaluated.

Methods: The three LCA tuning methods evaluated are: (M1) A digital light projector (DLP) illuminated by three LEDs (460, 530 & 630 nm central wavelength (λs), 10 nm band width (BW) filters), with dichroic mirrors to split/recombine the image and optotunable lenses (TL) controlling defocus λ independently, similarly as shown and described above in accordance with FIG. 4; (M2) A DLP with a supercontinuum laser and an acousto-optic tunable filter sweeping 3 nm BW λs synchronized with a temporal multiplexing TL, similarly as shown and described above in accordance with FIGS. 1-3; and (M3) Diffractive lenses designed (2π phase-wrapping) for 530 nm mapped on a spatial light modulator illuminated with λs, inducing wavelength dependent defocus.

Wavefronts (WF) were measured with an HS wavefront sensor (68×50 lenslets) for different accommodative demands (0 to 3 D) while subjects fixated on a polychromatic target under the following LCA conditions; natural (N), corrected (C), reversed (R), or doubled (D). AL was calculated from WF-based retinal image quality represented as area under AL-AD curves (AUL). The three methods (M1-M3) were demonstrated on 1 subject, and M1 on 3 subjects (average spherical error:−0.15±0.8 D; age: 26±3.5 yrs).

Results: M1 reproduced any chromatic defocus function within 0.05 D accuracy. M2 cycled λs at 33 Hz, with focusing accuracy of ±0.13 D, as tested in a custom developed high-speed focimeter. In M3, 5.6% & 11.1% of the energy in blue and red respectively was lost to higher diffraction orders. M1 and M3 matched AUL results within 0.25 D, while differences across conditions were attenuated in M2. The mean AULs (n=3) were 0.86 D (N), 1.1 D (C), 1.9 D (R), 1.2 D (D). Relative to N, the C AUL decreased by 0.6 and 0.3 for subjects 2 and 3 respectively.

Conclusions: LCA was successfully manipulated with 3 methods, with similar general performance, but M3 exhibited significant loss of energy for wavelengths other than the design wavelength of the diffractive lens designs. In all subjects, flipping the sign of LCA caused degraded accommodation accuracy by 1 D AUL. In two subjects, AL improved with LCA-corrected polychromatic targets, resulting in low hyperopic defocus on the retina. This might have the potential to slow down myopia progression.

### Selected Features of Temporal Multiplexing Method

The LCA induction is fully tunable and can be corrected, reversed, doubled, overcorrected, etc. Additionally, the chromatic difference of focus does not need to be necessarily linear and the system can be adapted to any LCA function. If the DLP projector is illuminated by the supercontinuum laser embodiment, the primary color can be selected from the entire visible spectrum with narrow band width using AOTFs (which are set to work with laser light). In this approach it is possible to display targets with high brightness.

In another embodiment (not illustrated), the supercontinuum laser plus AOTF system 100 could be replaced by an RGB-LED projector with high frequency turn on/off capability or a white-LED with rotating color filter wheel which would be synchronized with the optotunable filter. It should also be noted that the RGB-LED option also opens the possibility for correction of TCA.

Additionally, the system 100 can operate as a stand-alone projector system with chromatic manipulation control.

### Selected Features of Static Method

The LCA induction is fully tunable and can be corrected, reversed, doubled, overcorrected, etc. Additionally, the chromatic difference of focus does not need to be necessarily linear and can be adapted to any LCA function. The focus setting for each wavelength may be totally independent for each wavelength and no ripples or dynamic effects which may be associated with an optotunable lens driven at high speeds. Further, the three color channels can be laterally shifted for custom correction of TCA and the system can operate as a stand-alone projector system with chromatic manipulation control.

In the above-described embodiments, one or more control units may be configured to control various operations of the systems. For example, in all embodiments a control unit may be configured to generate one or more drive signals for the optotunable lens(es) employed to induce a desired amount of defocus independently in each separate color channel, and in the temporal multiplexing embodiments to generate one or more control signals to drive the acousto-optic tunable filter employed with a supercontinuum output laser, pulsing of RGB channels in an LED display, or timing of a color wheel with a white-LED display. Additionally, the control unit(s) may be configured to control relative lateral movement of spatially separated color channels when recombined to provide for controlled correction of TCA. The control unit(s) employed may comprise various computing devices, such as processors or microprocessors, controllers or microcontrollers, application specific integrated circuits, or the like.

It will be appreciated that variants of the above-disclosed embodiments and other disclosed features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for the manipulation of chromatic aberration in an image viewed by a person in a tunable manner, comprising using one or more optotunable lenses to control focusing of two or more temporally or spatially separated different wavelengths of visible light independently, and combining the independently controlled different wavelengths of light into a viewed polychromatic image, thereby allowing controlled correcting, overcorrecting, or reversing the natural chromatic aberration of the eye or imposing the chromatic aberration imposed by a given correction.

2. The method of claim 1, wherein visible light from a display is spatially split into two or more distinct visible wavelength channels using dichroic mirrors and color filters, with each channel provided with an optotunable lens that allows adjusting the focus for each channel independently, and further comprising tuning the optotunable lens in each channel independently to modify the chromatic difference of focus between each channel as desired, and recombining and superimposing the independently focus controlled channels to produce a polychromatic image with controlled chromatic aberration viewed by a user.

3. The method of claim 1, wherein the two or more distinct visible wavelength channels include distinct RGB channels.

4. The method of any one of claims 1, wherein the distinct visible wavelength channels each have band widths of less than or equal to about 15 nm.

5. The method of any one of claims 1, wherein the distinct visible wavelength channels each have band widths of less than or equal to about 10 nm.

6. The method of any one of claims 1, further comprising relatively laterally shifting at least two of the combined independently controlled different wavelengths of light in the viewed polychromatic image to manipulate Transverse Chromatic aberration.

7. The method of claim 1, wherein two or more visible wavelengths of light from a light source are temporally separated and are superimposed by temporal multiplexing, and a single optotunable lens is driven in a cycling sequence at a high speed in synchronization with the temporal multiplexing to independently adjust the focus for each superimposed channel in a viewed display and produce a polychromatic image with controlled chromatic aberration viewed by a user.

8. The method of claim 7, wherein color sweeping in the viewed display is achieved by use of a supercontinuum laser coupled with an acousto-optic tunable filter.

9. The method of claim 8, wherein the acousto-optic tunable filter sweeps 3 nm BW λs synchronized with the temporal multiplexing optotunable lens.

10. The method of claim 7, wherein color sweeping in the viewed display is achieved by RGB LED pulsing.

11. The method of claim 7, wherein color sweeping in the viewed display is achieved by a combination of the display and a rotating filter wheel.
